(19) United States
(12) Patent Application Publication
(10) Pub. No.: US 2008/0155170 A1
(43) Pub. Date: Jun. 26, 2008

(54) Utilization of scan structures and on-chip memory for retaining block state information during power down

(76) Inventors: Mirza M. Jahan, Chandler, AZ (US); Rajagopalan Srinivasan, El Dorado Hills, CA (US); Manish Dandekar, Roseville, CA (US)

Correspondence Address: INTEL CORPORATION;c/o INTELLEVATE, LLC, P.O. BOX 52050, MINNEAPOLIS, MN, 55402, US

(21) Appl. No.: 11/644,510

(22) Filed: Dec. 22, 2006

(51) Int. Cl. G06F 12/00

(52) U.S. Cl. 711/100; 711/E12.001

(57) ABSTRACT

A method, system and apparatus to retain the state of a block in a local memory utilizing the block's scan structures. A controller may configure the scan chains and may enable the transfer of state information between the block and the local memory.

### FIELD

Embodiments described herein relate to the field of electronic circuits. Some embodiments pertain to integrated circuits including sequential elements that are capable of being configured as scan chains.

### BACKGROUND

As semiconductor processing technology continues to advance with increases in transistor density, reduced die area, and improved transistor performance, leakage currents have also increased. In the past, this leakage current has been small in comparison to total chip power; however, with advancing technologies, leakage current has become one of the most significant components of the overall power budget.

Increasing leakage current is a concern for systems that rely heavily on batteries, such as wireless communication devices and handheld computing devices. During normal operation of such devices, non-contributing blocks may be powered down for significant power savings due to avoidance of leakage current. This will reduce overall power consumption due to leakage current, thus increasing battery life in battery powered devices.

When a block is powered down, the state of the block must be retained during the power down period. State retention is required so that when the block is turned back on, it returns to the same state it was in before it was powered off.

### DESCRIPTION OF THE DRAWINGS

A better understanding of embodiments of the present invention can be obtained from the following detailed description in conjunction with the following drawings, in which:

FIG. 1 is a block diagram illustrating scan drowsy operations when a block is powered on according to some embodiments.

FIG. 2 is a block diagram illustrating scan drowsy operations when a block is powered off according to some embodiments.

FIG. 3 is an illustration of a finite state machine for a scan drowsy controller according to some embodiments.

FIG. 4 is an illustration of a timing diagram for scan drowsy operations according to some embodiments.

FIG. 5 is an illustration of a system according to some embodiments.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

As used herein, a “block” is defined as a unit or sub-circuit within an integrated circuit that is capable of being powered on and off independently of the entire integrated circuit and independently of other units or sub-circuits within the integrated circuit. Examples of blocks may include, but are not limited to, a radio, a universal serial bus (USB) port, a graphics core, or a display unit.

As used herein, a “scan structure” and “scan chain” are defined as a plurality of sequential elements, such as flip-flops or latches, within a block that are connected in such a manner that they act as a shift register. The terms “scan structure” and “scan chain” may be used interchangeably. Typically, scan structures are used in test mode for manufacturing testing and design debug purposes. In some embodiments described herein, scan structures are utilized in a non-test mode to transfer a block's state information to local memory before power is removed from the block. This may be referred to as a “scan drowsy” operation.

As used herein, an “active mode” is a mode in which a block is powered-on. A “drowsy mode” is a mode in which a block is powered off.

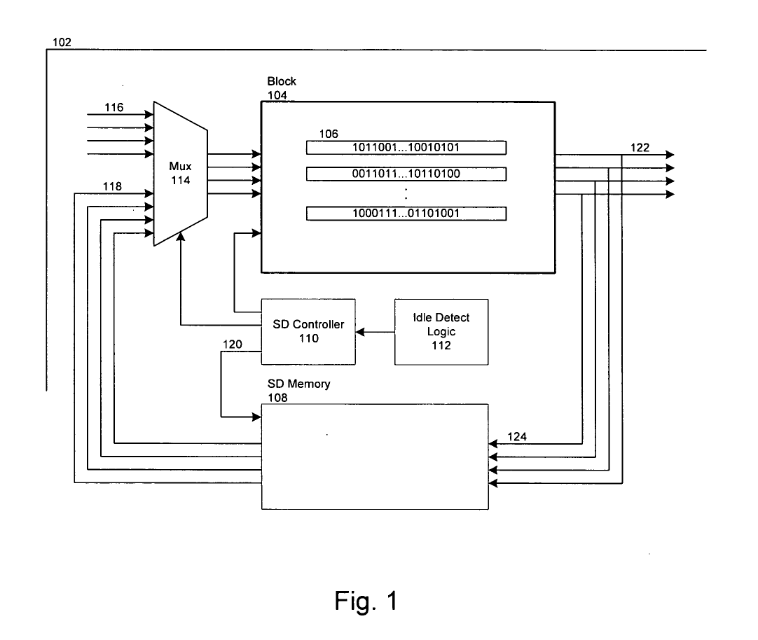

FIG. 1 is a block diagram illustrating scan drowsy operations for a block when the block is powered on according to some embodiments. The block (104) may be part of an integrated circuit (102).

A block (104) may include one or more scan chains or scan structures (106). When the integrated circuit (102) is in test mode, the outputs of the scan chains (122) may drive the scan chains in another block (not illustrated). When the integrated circuit (102) is in test mode, the inputs to the scan chains are driven by scan chains in a previous block (116). The inputs to the scan chains may be multiplexed (114) with inputs (118) from a scan drowsy memory (108).

When a block is in an active mode, the sequential elements that comprise the scan chains within the block are not connected to form scan chains. However, the sequential elements may be configured as scan chains (106) when a predetermined condition or predetermined set of criteria are met. These scan chains (106) provide a snapshot of the state of the block (104) at any given time.

A scan drowsy controller (110) coupled to the block (104) may detect when the block should enter an idle or low power mode, such as a drowsy mode. In some embodiments, idle detect logic (112) may detect that the block has met the conditions required to enter a low power mode. The scan drowsy controller (110) may then assert a signal to configure the block (104) to enter the low power scan drowsy mode. Upon entry into scan drowsy mode, the block's scan chains (106) are configured just as they would be during test mode. Thus, the scan chains (106) provide a snapshot of the state of the block (104) at the time it enters the low power mode. The scan drowsy controller (110) may then enable transfer of state information between the block (104) and on-chip scan drowsy memory (108) via interconnects or busses (118, 124).

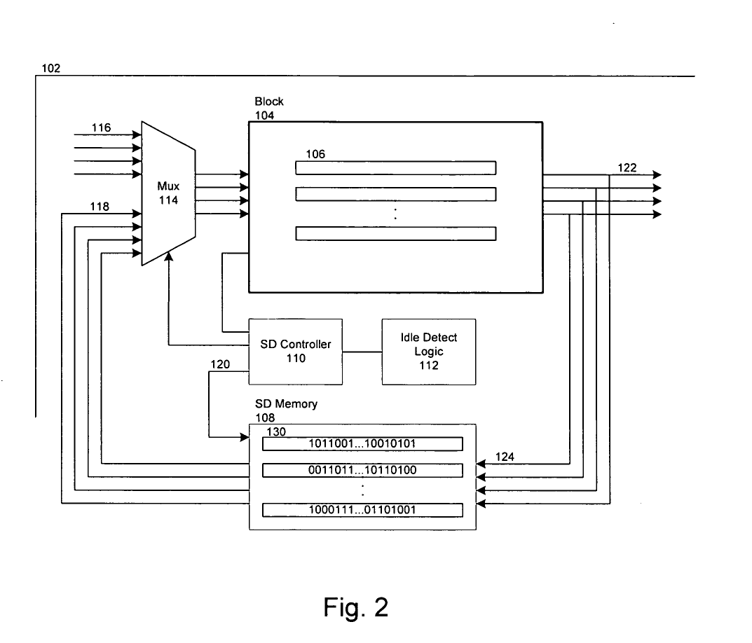

FIG. 2 illustrates scan drowsy operations for a block when the block is powered off according to some embodiments.

After the transfer of state information from the block (104) to scan drowsy memory (108) via the native scan structures (106), the block enters drowsy mode, and is powered off. This may reduce both active power and leakage power for the block. The block's state information (130) is stored in the scan drowsy memory (108) until the block is about to resume normal operations. At this time, the state information may be restored to the block from the scan drowsy memory, again utilizing the block's native scan structures. The scan drowsy controller (110) controls scan drowsy operations and performs the transfer of state information between the block and memory between active and drowsy modes.

In some embodiments, the scan drowsy memory (108) that is used to store block state information may be a local, or on-die, embedded SRAM. The size of the memory may be determined based on the number of sequential elements and the number of scan chains in a block. For example, assume a block that consists of X sequential elements that are connected to form Y scan chains, where each chain includes Z=X/Y sequential elements. In this case, the scan drowsy memory may be of width Y and depth Z, so that the contents from Y scan chains can be uploaded or downloaded in parallel from memory. Thus, the input (124) and output (118) busses to the scan drowsy memory may have a width equal to at least Y bits in some embodiments. Additionally, in some embodiments, an address signal generated by the scan drowsy controller may have a width of log₂(Z) bits. In some embodiments, it may take at least Z scan clock cycles to transfer the contents between X sequential elements in the block and the scan drowsy memory.

The read, write, and address ports of the scan drowsy memory (108) may be multiplexed during scan drowsy operations in some embodiments. This may help to ensure that changes made at these ports during scan drowsy operations do not affect functional paths.

In some embodiments, a single scan drowsy memory may be used to store block state information for multiple blocks at one time. In this case, the size of the scan drowsy memory will need to be adequate to store the block state information for all blocks that will be powered off at the same time. Additionally, the width of the input and output busses of the scan drowsy memory may have a width that is at least equal to the maximum number of scan chains in any one block.

Scan drowsy operations are controlled by a scan drowsy controller (110). In some embodiments, the scan drowsy controller may be implemented as a finite state machine.

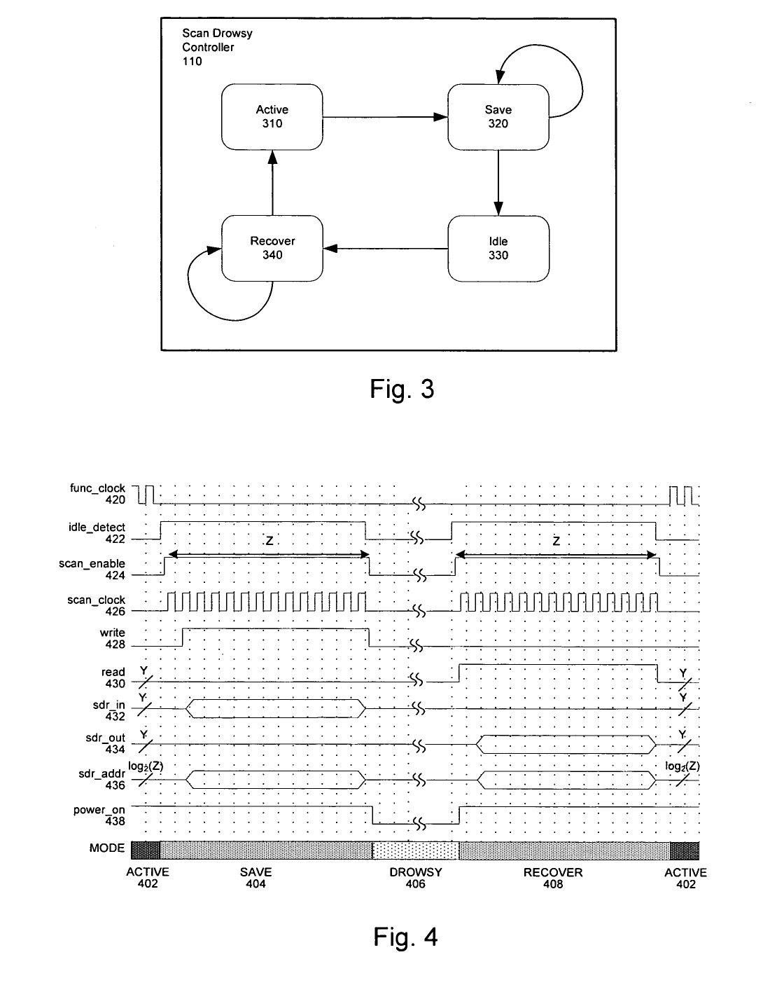

FIG. 3 illustrates a finite state machine for a scan drowsy controller (110) according to some embodiments. The controller may enter a state based on a predetermined set of criteria.

The scan drowsy controller has four states: Active (310), Save (320), Idle (330), and Recover (340). These states may correspond to the modes of one or more blocks.

While the scan drowsy controller is in the active state (310), the block it controls operates in its normal functional mode. In this mode, all sequential elements in the block are driven purely by the block's functional specifications, and no scan chains are configured. In this mode, the block may operate at the specified operating power. In various embodiments, the scan drowsy memory may operate at full power, low power, or may be powered off when the scan drowsy controller is in the active state.

The scan drowsy controller performs a save operation for a block during the save state (320). First, the controller may assert a scan mode signal to the block. This configures the block's scan chains as they would be configured during a test mode. The controller may then use the newly configured scan chains to perform a cycle-by-cycle shift of the block's state information from the scan chains to the scan drowsy memory. In some embodiments, the scan chain output signals from the block are routed to the write ports of the scan drowsy memory. Thus, the state of the block is stored into memory via the block's scan chains.

In some embodiments, any scan chain output ports at the IC output level may be disabled to prevent corrupt data from being sent at a system level.

A shift operation transfers a block's state information from the scan chains to memory. The shift operation may be performed using a shift clock. In some embodiments, the shift clock may be generated by the scan drowsy controller.

An address counter inside of the scan drowsy controller may generate the addresses required to store the scanned out state information. In some embodiments, the number of clock cycles required to perform the save operation may be equal to or greater than the number of sequential elements in the longest scan chain in the block. Thus, a shorter time may be required to save state information using shorter scan chains, while a longer time may be required to save state information using longer scan chains.

The idle state (330) corresponds to a block's drowsy mode. During drowsy mode, power savings may be realized, because after a block's state information has been saved the block may be powered down. The scan drowsy controller enters the idle state when predetermined criteria are met for a block. These criteria may be established by the IC designer based on the conditions that should be met in order for a block to enter this low power mode. During the idle state, when a block is in drowsy mode, the values of all sequential elements in the block are saved in a scan drowsy memory. In the idle state, both the scan drowsy controller and the scan drowsy memory are powered on, while one or more blocks are powered off. Upon entering the idle state, the scan drowsy controller may power off a block by asserting a power off signal or by de-asserting a power on signal.

During the recover state (340), the scan drowsy controller controls the recover operation to restore a block's state information so that the block may be powered on. Based on predetermined criteria, the scan drowsy controller first sends appropriate signals to power on the block. Next, it enables scan mode for the block, thus configuring the block's scan chains as they would be in test mode. The controller uses the block's scan chains to perform a cycle-by-cycle shift of state information from the scan drowsy memory to the block.

As described above, after a save operation is performed the scan drowsy memory contains the block's previously saved state information. This saved state information is transferred from the scan drowsy memory back to the block during the recover operation.

The shift process used to transfer the state information from the scan drowsy memory to the block's scan chains is performed using the same shift clock used during the save operation. The scan drowsy controller also generates the addresses required for the transfer of state information from scan drowsy memory back to the block. In some embodiments, the number of clock cycles required to perform the recover operation is equal to or greater than the number of sequential elements in the longest scan chain in the block. Thus, a shorter time is required to restore state information using shorter scan chains, while a longer time is required to restore state information using longer scan chains.

After the contents of memory have been shifted into the block's scan chains, the recover operation is complete. The scan drowsy controller may then reconfigure the sequential elements in the block into an operational configuration, such that the block may now operate in the manner for which it was designed during an active mode. Thus, after the recover operation is complete, the block's scan chains are no longer configured as such.

FIG. 4 is an illustration of a timing diagram for scan drowsy operations according to some embodiments. There are four modes of operation for a block: active (402), save (404), drowsy (406) and recover (408). These four modes of operation correspond to the four scan drowsy controller states described above with respect to FIG. 3.

During the active mode, clock func_clock (420) toggles. This clock is turned off during the save, drowsy, and recover modes.

The idle_detect signal (422) may be generated by idle detect logic. This signal is triggered when predetermined system requirements are met. When the idle_detect signal (422) is set, the scan drowsy controller may toggle a block between active and drowsy modes. The idle_detect signal (422) also triggers the scan drowsy controller to generate the scan_enable signal (424).

When the scan_enable signal (424) is asserted by the scan drowsy controller, a block's scan chains are configured, which allows the block's state information to be shifted out of the scan chains and into memory during save mode, or out of memory and into the scan chains during recover mode.

During save mode, the scan drowsy controller generates a memory write signal (428) and pulses the scan_clock (426) to shift the contents of the block's scan chains into memory. Clock scan_clock (426) toggles until the contents of the block's scan chains, sdr_in (432) are transferred from the block into memory. The scan drowsy controller generates the addresses of the locations where the scanned out state information is to be stored in memory, sdr_addr (436).

After the contents of all of a block's sequential elements are transferred to the scan drowsy memory (i.e. after Z scan clock cycles), the scan drowsy controller turns the block's power off. In some embodiments, the scan drowsy controller may turn a block's power off by deasserting a power_on signal (438).

When the block is in drowsy mode (406), power to the block is turned off, and there will be no leakage power consumption, thus resulting in power savings.

Upon exiting drowsy mode, the block enters recover mode. In recover mode, the scan drowsy controller asserts the power_on signal (438), to power the block. The controller also asserts the scan_enable signal (424) to configure the block's scan chains, allowing the block's state information to be shifted out of memory and into the scan chains.

The scan drowsy controller generates a memory read signal (430) and begins shifting the stored state information from the scan drowsy memory into the scan chains. Clock scan_clock (426) toggles until the block's state information, sdr_out (434) is transferred from memory into the block's scan chains. The scan drowsy controller generates the addresses of the locations where the state information is to be read from memory, sdr_addr (436).

After the block's state information is restored to the sequential elements from memory (i.e. after Z scan clock cycles), the scan_enable signal (424) is deasserted, and the block's sequential elements are configured as required for normal operation of the block and are no longer configured as scan chains. The block may then resume normal operation in active mode (402).

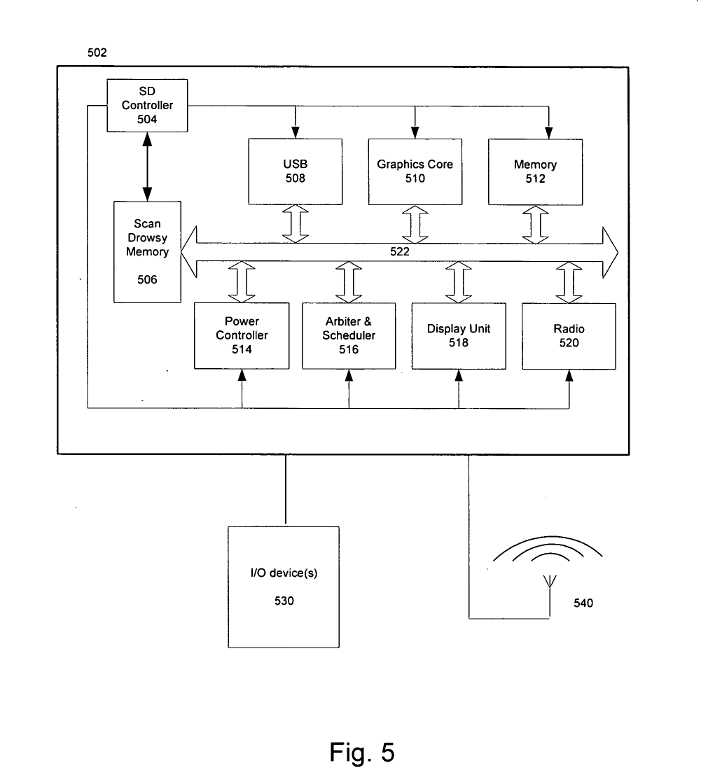

FIG. 5 is a block diagram of a system according to one embodiment. In some embodiments, the system may include a system on a chip (SoC) integrated circuit (IC) (502).

The system on a chip IC (502) may include one or more functional blocks. For example, these blocks may include, but are not limited to, a universal serial bus (USB) block (508), a graphics core block (510), a memory block (512), a power controller block (514), an arbiter and scheduler block (516), a display unit block (518) and a radio block (520). Each block may be capable of being powered on and/ or off independently of each other block. Each block may include one or more scan chains or scan structures, as described above with respect to FIGS. 1 and 2.

The system on a chip IC (502) may also include a scan drowsy controller (504) and scan drowsy memory (506), as described above with respect to FIGS. 1-3. The scan drowsy controller (504) may be coupled to one or more blocks (508-520) and to the scan drowsy memory (506). The scan drowsy controller (504) may detect when a block is to transition from an active state to a drowsy state or from a drowsy state to an active state. The scan drowsy controller (504) may also manage the transfer of state information to and from the scan drowsy memory (506) for a block.

One or more blocks (508-520) may be coupled to the scan drowsy memory (506) by a bus or interconnect (522). In some embodiments, the width of the interconnect may be determined by the maximum number of scan chains in a block. That is, the interconnect may be at least as wide as the maximum number of scan chains in any block in order to facilitate parallel scan out of block state information.

One or more input/output (I/O) devices (530) may be coupled to the system on a chip IC (502). The I/O devices may include, but are not limited to, items such as a display, keyboard, mouse, touch screen, or other I/O devices.

In some embodiments, an antenna (540) may also be coupled to the system on a chip IC (502) to provide wireless communications via the radio block (520). The antenna may be a directional antenna or may be an omnidirectional antenna. The antenna may enable wireless communication between the system and other devices.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, apparatus, and system for utilization of scan structures and on-chip memory for retaining block state information during power down are disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
transferring state information for a block to a local memory using a plurality of scan chains; and
powering off the block.

2. The method of claim 1, wherein each of the plurality of scan chains includes a number of sequential elements, and wherein transferring the state information for the block to the local memory occurs over a number of clock cycles that is equal to the maximum number of sequential elements in one of the plurality of scan chains.

3. The method of claim 1, further comprising determining that the block should be powered on based on a predetermined set of criteria.

4. The method of claim 3, further comprising powering on the block and restoring the state information to the block from the local memory via the plurality of scan chains.

5. The method of claim 4, further comprising de-asserting a scan mode signal to reconfigure the plurality of scan chains into a plurality of sequential elements.

6. The method of claim 1, wherein the local memory is an on-die SRAM memory.

7. The method of claim 6, wherein the on-die SRAM memory has a size that is at least as great as the number of sequential elements in the plurality of scan chains.

8. The method of claim 1, further comprising asserting a scan mode signal to configure the block's scan chains prior to transferring state information for the bock to the local memory.

9. A method comprising:
detecting when a first predetermined condition has been met for a block;
configuring a plurality of sequential elements into a plurality of scan chains;
shifting data from the plurality of scan chains into a local memory;
powering off the block;
detecting when a second predetermined condition has been met for the block;
powering on the block;
shifting data from the local memory into the plurality of scan chains; and
reconfiguring the plurality of sequential elements from scan chains into an operational configuration.

10. The method of claim 9, wherein shifting data from the plurality of scan chains into a local memory comprises providing a shift clock and a plurality of addresses.

11. The method of claim 9, wherein shifting data from the local memory into the plurality of scan chains comprises providing a shift clock and a plurality of addresses.

12. The method of claim 9, wherein the local memory is an on-die SRAM memory.

13. An apparatus comprising:
a block including a plurality of scan chains;
a memory coupled to the block; and
a controller coupled to the block to control data transfer between the plurality of scan chains and the memory.

14. The apparatus of claim 13, further comprising idle detect logic coupled to the controller.

15. The apparatus of claim 14, wherein the idle detect logic is to monitor operation of the block.

16. The apparatus of claim 13, wherein the memory is an on-die SRAM.

17. The apparatus of claim 13, wherein the controller is a finite state machine.

18. The apparatus of claim 17, wherein the controller is capable of entering one of an idle, save, recover, and active states.

19. A system comprising:
a system-on-a-chip (SOC), wherein the SOC includes a block having a plurality of scan chains, a memory coupled to the block, and a controller coupled to the block to control data transfer between the plurality of scan chains and the memory; and
an antenna coupled to the SOC to enable wireless communications.

20. The system of claim 19, wherein the memory is coupled to the block via an interconnect having a width that is at least equal to a number of scan chains in the block.

21. The system of claim 19, wherein the block is a radio block.
